(19) United States
(12) Patent Application Publication
(10) Pub. No.: US 2008/0097691 A1
(43) Pub. Date: Apr. 24, 2008

(54) VEHICLE NAVIGATION SYSTEM

(75) Inventor: Kai Seifried, Buhl (DE)

Correspondence Address: THE ECLIPSE GROUP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 11/874,802

(22) Filed: Oct. 18, 2007

(30) Foreign Application Priority Data
Oct. 18, 2006 (EP) 06 021 883.1

(51) Int. Cl. G01C 21/34; G01C 21/30

(52) U.S. Cl. 701/209; 701/200; 701/224

(57) ABSTRACT

A navigation system is provided in a vehicle. The navigation system operates using a dedicated operating mode for generating navigation information and outputting such information to the vehicle user when a relevant event has occurred. The navigation system includes a positioning device for determining the vehicle position with respect to a digital map representation and for generating a corresponding position data signal, a traffic monitoring device for receiving traffic information data and analyzing the traffic information data so as to detect a relevant event relating to a travel route on which the vehicle moves, where the traffic monitoring device generates a corresponding traffic monitoring data signal. The system includes a processing unit for generating navigation information based on the position data signal and/or the traffic monitoring data signal, and an output device for outputting the navigation information to a vehicle user.

### RELATED APPLICATIONS

This application claims priority of European Patent Application Serial Number 06 021 883.1, titled METHOD OF OPERATING A NAVIGATION SYSTEM IN A VEHICLE AND VEHICLE NAVIGATION SYSTEM and filed on Oct. 18, 2006, which application is incorporated in its entirety by reference in this application.

### BACKGROUND

1. Field of the Invention

The invention relates to navigation systems, and more particularly to navigation systems in vehicles.

2. Related Art

Navigation systems are finding increasing use in vehicles to provide a vehicle user, the driver, with navigation instructions that help orient the driver when traveling unknown routes. In general, a navigation system includes a positioning device, which is typically based on a positioning system such as the global positioning system (GPS), for determining the vehicle's position with respect to a digital map representation. Navigation systems also typically include a processing system and suitable hardware and software to generate navigation information and the navigation instructions conveyed to the driver using the vehicle position and user input information such as a user-selected navigation route.

Improved functionality of the navigation system may be obtained by using traffic information data when generating the navigation information. The traffic information data may be obtained from a Traffic Message Channel (TMC), which is a publicly available digital radio data service used for broadcasting information on traffic conditions to suitable receiver devices. The traffic information may be used by the navigation system to instruct the driver on routes that avoid the traffic obstruction.

However, the driver often knows the travel routes commonly traveled and may often keep the navigation system deactivated to avoid being disturbed or annoyed by unnecessary navigation instructions. If the driver keeps the navigation system deactivated, the driver will not receive the benefits of receiving traffic information data in the navigation system. For example, the driver may encounter traffic obstructions along the travel route that the navigation system would have helped the driver avoid.

There exists a need to improve existing navigation systems in such a way that the driver can benefit from the functions of the navigation system even when traveling on a well-known route, without being disturbed or irritated by unnecessary navigation information.

### SUMMARY

In view of the above, a method of operating a navigation system in a vehicle is provided. Traffic information data is received by the navigation system. A travel route on which the vehicle is moving is determined. The traffic information data is analyzed to determine if a relevant event related to the travel route is detected. If a relevant event is detected, a corresponding navigation information signal is output to alert the vehicle user.

In another aspect of the invention, a vehicle navigation system includes a positioning device for determining a vehicle position with respect to a digital map representation and for generating a corresponding position data signal. A traffic monitoring device receives traffic information data and analyzes the traffic information data to detect a relevant event relating to a travel route on which the vehicle moves. The traffic monitoring device generates a traffic monitoring signal corresponding to the relevant event. A processing system generates navigation information on the basis of the position data signal and/or the traffic monitoring data signal. An output device is used to output the navigation information to a vehicle user. The processing system includes a dedicated operating mode in which the navigation information is output to the vehicle user only if a relevant event is detected by the traffic monitoring device.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The example implementations of the invention described below may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic diagram of an example vehicle navigation system configured to process traffic information data.

FIG. 2 is a schematic diagram of a map depicting a predefined route and an alternative navigation route generated using an example method consistent with the invention.

FIG. 3 is a flowchart depicting operation of an example method of operating a navigation system in a vehicle.

### DETAILED DESCRIPTION

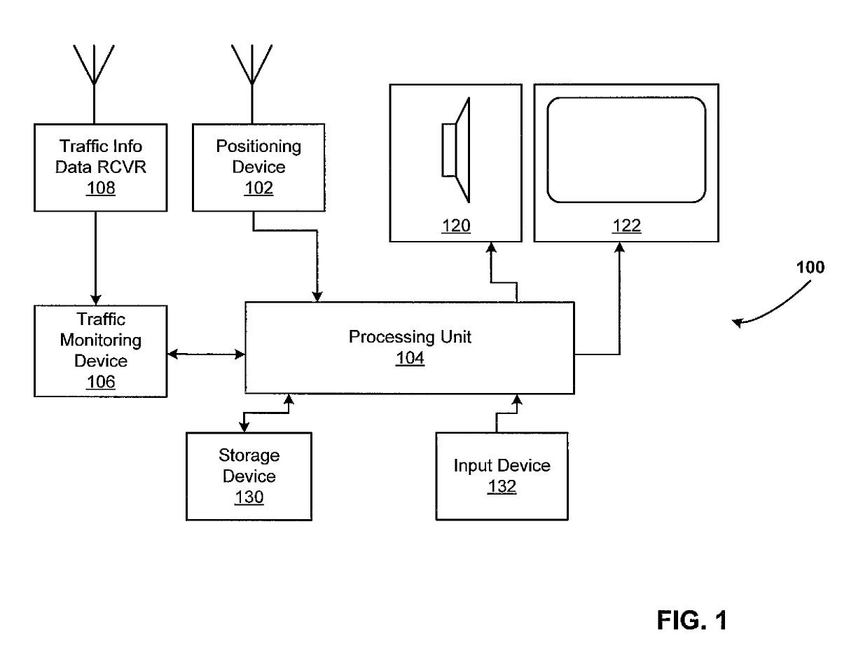

FIG. 1 is a schematic diagram of an example vehicle navigation system 100 configured to process traffic information data. The navigation system 100 includes a satellite-based positioning device 102, which determines the position of a vehicle in which the navigation system 100 is installed with respect to a digital map representation. For example, the positioning device 102 may include a GPS receiver or a comparable satellite positioning system receiver for receiving positioning signals from navigation satellites. The digital map representation may be stored in a storage device 130, which may include, for example, a hard disk device, a CD-ROM device, a DVD device, a ROM memory device, or any other suitable storage devices. In addition, rewritable non-volatile memory, such as flash memory, may be provided to store processing information in a flexible way and to maintain the stored information even in the case of a power outage.

The navigation system 100 in FIG. 1 generates navigation information on the basis of position data obtained using the positioning device 102. The navigation information may include navigation instructions, which may include for example, indications of which action should be taken in order to navigate the vehicle on a preselected navigation route (e.g., “turn left”, “turn right”, or “follow the course of the road”). The navigation information may also include warnings relating to the navigation route, such as for example, with respect to abnormal road conditions, speed limits or other conditions. The navigation system 100 may include output devices to present or annunciate the navigation information to the vehicle user. The output devices may include a loudspeaker device 120 and/or an optical display device 122. The loudspeaker device 120 may be a dedicated component of the navigation system 100. The loudspeaker device 120 may also be a component of a vehicle entertainment system, such as a car radio, CD player, MP3 player, tape player, or a combination of such devices. If the navigation system 100 shares use of the loudspeaker device 120 with a vehicle entertainment system, the navigation system 100 includes an interface to permit transmission of the output signals corresponding to navigation information to the vehicle entertainment signal. This may be accomplished via a digital data bus in the vehicle.

The optical display device 122 may be a full graphic display, such as for example, a liquid-crystal display, a thin-film transistor display or a cathode-ray tube display. The optical display device 122 may also be a projection display, such as a head-up display in which optical information is projected onto a windscreen of the vehicle. The optical display device 122 may also be combined with an input device. For example, the optical display device 122 may be configured as a touchscreen device. The optical display device 122 may be a dedicated component of the navigation system, or may be used together with other vehicle systems, such as for example, a multi-media system.

The navigation system 100 includes a processing unit 104 for generating the navigation information. The processing unit 104 may be coupled to the positioning device 102 to receive a position data signal, to the loudspeaker device 120 to provide an acoustical output data signal, and to the optical display device 122 to provide an optical output data signal. The processing unit 104 may also be coupled to the storage device 130 to receive digital map data and to receive and transmit a processing data signal. The processing unit 104 evaluates position data received via the position data signal and digital map data received from the storage device 130 to generate navigation information to be output to the vehicle user. The output navigation information may be a corresponding acoustical output signal and/or optical output signal.

The processing unit 104 may also be coupled to an input device 132 to provide the vehicle user with control over functions of the processing unit 104. The input device 132 may include suitably designed switches and/or a keyboard. The input device 132 may be used to activate or deactivate the navigation system, to select the navigation route, to select between different display modes. Such modes may include, for example, a mode providing for acoustic output of navigation information only, a mode for optical output of navigation information only, or a mode providing for both acoustical and optical output of navigation information), or other suitable modes.

As shown in FIG. 1, the navigation system 100 includes a traffic monitoring device 106 coupled to the processing unit 104 to provide a traffic monitoring data signal. The traffic monitoring device 106 is coupled to a traffic information data receiver 108, which is configured to receive a broadcast traffic information data signal, such as that of a TMC service. In the description below, use of the TMC service is assumed, however, any suitable alternative system, whether public or not, may be used as well.

The traffic information data signal contains traffic information that may be evaluated in relation to a travel route on which the vehicle moves. In normal operations of the navigation system 100, the travel route may be the navigation route selected by the vehicle user. The traffic information data receiver 108 may be integrated with the navigation system 100 or may be a component of another vehicle system, for example, a vehicle entertainment system or a car radio. If the traffic information data receiver 108 is a component of another system, the navigation system 100 is provided with a suitable interface to receive traffic information data signals from the traffic information data receiver 108. A suitable interface may be implemented, for example, via a digital data bus of the vehicle.

The traffic monitoring device 106 may evaluate the traffic information data received via the traffic information data signal to detect a relevant event relating to the travel route on which the vehicle moves. The traffic monitoring device 106 may also receive a travel route information data signal from the processing unit 104. Typically, the travel route will be the navigation route selected by the vehicle user. A relevant event may be any type of traffic obstruction occurring in the travel route within a time interval in which the vehicle is expected to pass the location of the traffic obstruction. For example, traffic obstructions may be caused by accidents, road work or the like. If a relevant event relating to the travel route is identified by the traffic monitoring device 106, a corresponding traffic monitoring data signal is generated and provided to the processing unit 104. The processing unit 104 may generate the navigation information and include the traffic monitoring information received via the traffic monitoring data signal. For example, the loudspeaker device 120 and/or the optical display device 122 may be controlled to provide a warning to the vehicle user, and/or an alternative navigation route may be computed that avoids the traffic obstruction.

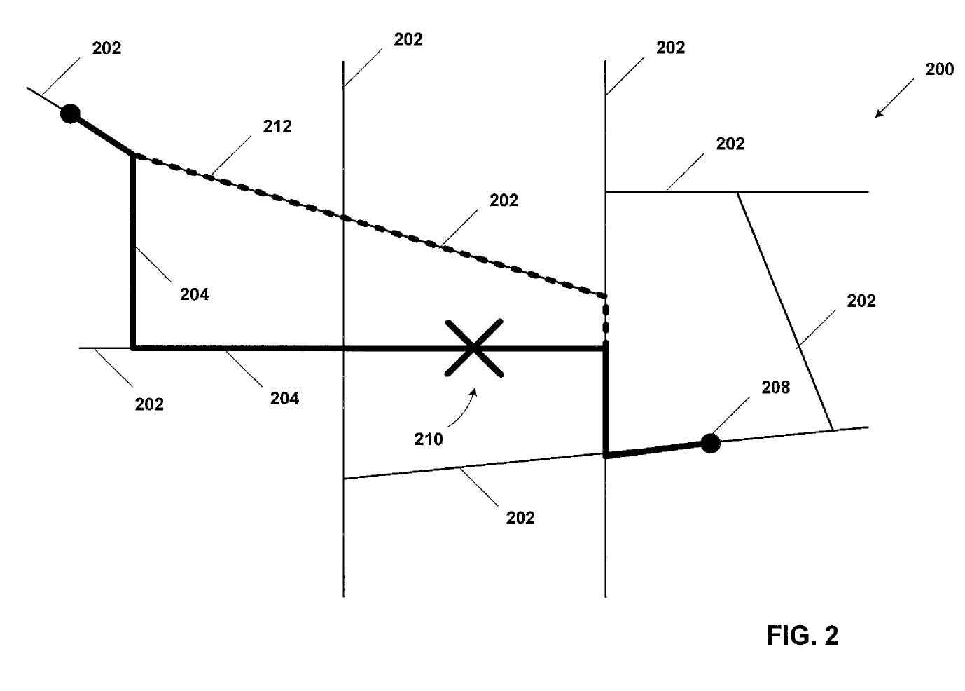

In the navigation system 100 in FIG. 1, the traffic information data is evaluated using the traffic monitoring device 106 as described further below with reference to FIG. 2. In the example described with reference to FIG. 2, the traffic information data includes data received via the TMC service. The TMC service is a digital radio service in which TMC signals are transmitted together with a radio program. The TMC data signal is broadcast continuously as messages that may contain information relating to traffic obstructions in a specific area. A separate message is transmitted for each traffic obstruction encountered. The message may contain an event code and a location code. The message may also contain a time-limitation code. If a traffic obstruction is no longer present, the message corresponding to this traffic obstruction may be cancelled by a subsequent message. If the receiver is not able to receive the canceling message, which may occur for example when the receiver has moved out of the receiving area, the message indicating the traffic obstruction may be cancelled when an expiration time elapses. The expiration time may be set by the time-limitation code.

The event code in the message may indicate a type of traffic obstruction. TMC data signals are based on a standard that provides a list of different events and their corresponding event codes. The receiver may include an encoded list based on the standard list to translate the event code into a corresponding event information.

The location code in the message may refer to a location table that may be publicly available on a national level. In each country there may be a specific location code corresponding to a specific road section.

The traffic monitoring device 106 may correlate the information contained in the event code, in the location code, and in the time-limitation code with the travel route information data received from the processing unit 104 and determine whether a traffic obstruction indicated by a received message is relevant or not. If determined to be relevant, the traffic monitoring device 106 may generate a corresponding traffic monitoring data signal.

The above description of the operation of the navigation system 100 in FIG. 1 is for a normal operating mode of the navigation system 100. The navigation system 100 generates navigation information to allow the vehicle user to navigate on a selected navigation route. However, when the vehicle user is traveling on a well-known route, for example when a vehicle user is traveling between home and work, such navigation information is not necessary. In such cases, the navigation information may actually be irritating or annoying. The vehicle user may tend to deactivate the navigation system 100 and no longer benefits from its functions.

The navigation system 100 in FIG. 1 may include a dedicated operating mode to be used when traveling on a well-known route, or at anytime the vehicle user considers navigation information to be undesirable for some reason. In the dedicated operating mode, the navigation system 100 does not output navigation information unless a relevant event is detected by the traffic monitoring device 106. Because the output of navigation information is suppressed in the operating mode, the operating mode may be referred to as a “silent” operating mode. In one example, the silent operating mode is activated by the vehicle user via the input device 132.

In normal operation a navigation route is selected by the vehicle user. The user may select a navigation route by defining at least a destination point. Additional parameters may be defined, such as desired travel speed, desired type of road, or other suitable parameters. The traffic monitoring device 106 evaluates the traffic information data with respect to the selected navigation route.

In the silent operating mode, the traffic monitoring device 106 evaluates the traffic information data with respect to a predefined route, such as for example, a frequently traveled route. After selecting the silent operating mode, the processing unit 104 provides the travel route information data signal according to the predefined route. The predefined route may be stored in the storage device 130. The storage device 130 may store a number of predefined routes, which can then be selected by the vehicle user via the input device 132. If a plurality of predefined routes is stored in the storage device 130, the processing unit 104 may be configured to select between the predefined routes in accordance with the position data received from the positioning device 102. The processing unit 104 may be configured to allow the vehicle user to provide input when the position data does not permit the system 100 to distinguish between two predefined routes. For example, if the vehicle is located on a road section forming part of more than one predefined route, the user may have to provide input to clarify which predefined route is to be used.

In the silent operating mode, the traffic monitoring device 106 continuously evaluates the traffic information data to detect if there is a relevant event relating to the selected predefined route. The processing unit 104 operates without outputting navigation information to the vehicle user. However, if a relevant event is detected by the traffic monitoring device 106, a corresponding traffic monitoring data signal is provided to the processing unit 104, and a navigation information is output to the vehicle user.

The type of navigation information output to the user may depend on the type of event detected by the traffic monitoring device 106. For example, an audible warning message may be output to the vehicle user. An alternative navigation route may also be computed by the navigation system. If an alternative navigation route is computed, the vehicle user may be informed by audible message that an alternative navigation route is available and that the user is allowed to select whether or not the alternative navigation route should be used for providing navigation information. If the vehicle user selects the alternative navigation route for further navigation, the navigation system 100 may revert to operating in a normal mode operation in which case, all of the navigational information is output. The navigation system 100 may also offer to change to another predefined route, and remain in the silent operating mode.

In some instances, the predefined route may correspond to a route that is frequently traveled by the vehicle user. The predefined route may be stored in the navigation system 100 by using a learning function. The processing unit 104 may learn the predefined routes by continuously evaluating the position data provided by the positioning device 102 to identify frequently traveled routes. The processing unit 104 may store each route traveled by the vehicle in the storage device 130 and compare the presently traveled route with previously stored routes. If the frequency of occurrence exceeds a threshold value, the presently traveled route is identified as a frequently traveled route. A message may be provided to the vehicle user identifying the frequently traveled route and the vehicle user may store the identified route as a predefined route that may be used in the silent operating mode.

In another example, predefined routes may be stored by manually activating a learning mode in the navigation system 100. For example, the vehicle user activates the learning mode indicating that a subsequently traveled route is to be stored as predefined route. After traveling the route to be stored, the learning mode is deactivated, and the traveled route is stored as a predefined route in the storage device 130. It is also possible to manually store predefined routes, for example by using the input device 132.

An example method for storing a predefined route is described below with reference to FIG. 2. FIG. 2 is a schematic diagram of a map representation 200 depicting a predefined route and an alternative navigation route generated using an example method. The map representation 200 includes a plurality of roads 202 and a predefined route 204 to be used in the silent operating mode of the navigation system 100 indicated by a thick line. The predefined route 204 includes a starting point 206 and an end point 208. When traveling on the predefined route 204, the navigation system 100 need not provide navigation information to the vehicle user since the predefined route 204 is known to the vehicle user. At the starting point 206, the vehicle user may activate the silent operating mode of the navigation system 100. If no relevant event is detected by the traffic monitoring device 106, the navigation system 100 suppresses all outputs of navigation information to the vehicle user throughout the predefined route 204.

If a relevant event is detected by the traffic monitoring device 106, navigation information is output to the vehicle user. In the example illustrated in FIG. 2, a traffic obstruction is illustrated by a cross 210 on the predefined route 204. Because the traffic obstruction is located on the predefined route, it is identified as a relevant event and the traffic monitoring device 106 generates a corresponding traffic monitoring data signal. The traffic monitoring data signal is communicated to the processing unit 104, which may respond by generating corresponding navigation information. In the example illustrated in FIG. 2, the navigation information may include a warning that there is a traffic obstruction. The warning may include information on the type and location of the traffic obstruction. The navigation information generated by the navigation system may also include information regarding an alternative navigation route 212 computed by the processing unit 104. The vehicle user may be able to decide which action should be taken. The vehicle user may recognize that the traffic obstruction is not a serious problem and choose to continue to follow the predefined route 20. Alternatively, the vehicle user may decide to use the alternative navigation route 212 and return the navigation system 100 to normal operation.

FIG. 2 illustrates an example in which an alternative navigation route 212 bypasses an intermediate section of the predefined travel route 204. The alternative navigation route 212 returns to the predefined route 204 before the end point 208 is reached. When the alternative navigation route 212 returns to the predefined route 204, the navigation system 100 may be configured to automatically return to the silent operating mode after the vehicle has returned to the predefined route 204. The positioning data received from the positioning device 102 may be used to detect when the vehicle has returned to the predefined route.

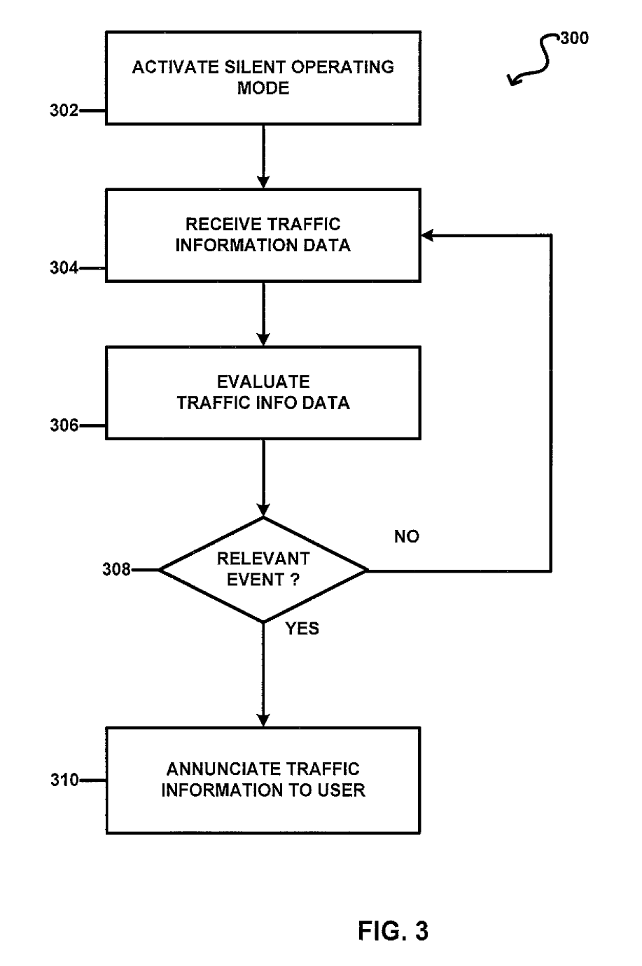

FIG. 3 is a flowchart depicting operation of an example method of operating a navigation system in a vehicle. In the description that follows, reference is made to the navigation system 100 in FIG. 1 for purposes of illustration. However, any other suitable navigation system may be used as well.

In step 302, the vehicle user may activate the silent operating mode. The vehicle user may activate the silent operating mode by using, for example, the input device 132 in FIG. 1. In step 304, the navigation system 100 receives traffic information data. The traffic information data may be received via the traffic information signal receiver 102 and the traffic monitoring device 106 as described above with reference to FIG. 1.

In step 306, the traffic information data is evaluated to determine if there is a relevant event relating to the travel route on which the vehicle is moving. Decision block 308 determines if relevant event was encountered. In general, any traffic obstruction to the vehicle when following the present travel route may be considered a relevant event. If no such event is detected, the navigation system 100 remains in its silent operating mode and the method returns to step 304 without outputting navigation information to the vehicle user.

If at decision block 308, a relevant event is detected, the traffic monitoring device 106 generates a corresponding traffic monitoring data signal, which is supplied to the processing unit 104. At step 310, navigation information is provided to the vehicle user. For example, the navigation information may be a warning relating to the detected traffic obstruction or may contain information on an alternative navigation route. In step 310, the vehicle user may decide whether to maintain the silent operating mode or to leave the silent operating and to use navigation instructions provided by the navigation system to navigate according to the alternative navigation route.

In examples described above, a predefined route was used for evaluating the traffic information data in the silent operating mode. In another example, the traffic information data may be evaluated using an expected travel route. The expected travel route may be determined by the processing unit 104 based on position data received from the positioning device 102. In one example, the expected course of the road may be determined by taking into account additional information, such as for example, the type of road on which the vehicle moves. Such information may be available from the digital map representation used for obtaining the position data. In another example, the expected course of the road may be determined from the travel route the vehicle has followed before the time of evaluation.

The expected travel route can be computed using the information described above. There is a probability that the expected travel route will be followed by the vehicle. Because traffic information relating to the expected travel route may aid the vehicle user, use of the expected travel route may be suitable for use in the silent operating mode of the navigation system 100.

To illustrate an example of determining the expected travel route, in a given situation, the vehicle may be moving on a motorway or other main traffic route. The vehicle may enter the main traffic route from a smaller road. In such a situation, it is likely that the vehicle will remain on the main traffic route for some time. Therefore, the course of the main traffic route ahead of the vehicle can be determined as the expected travel route.

It is also possible to operate given multiple expected travel routes. For example, if the course of the road ahead of the vehicle may branch out into two possible routes. In this case, the driver may choose from both possible routes for the travel route ahead with comparable probabilities. The navigation system 100 may then take into account both expected travel routes when evaluating the traffic information data.

Of course, it is possible to combine methods using predefined routes with methods using expected travel routes. For example, predefined routes may be used as a basis for identifying expected travel routes.

In the above-described examples of vehicle navigation systems and methods, a vehicle user benefits from use of the functions of the navigation system 100 even when traveling on a well-known route. It is to be understood that in the above-described examples, many modifications can be made. For example, although the traffic monitoring device 106 and the processing unit 104 have been illustrated as separate blocks in the diagram of FIG. 1, the corresponding functions may be implemented by suitable software running on a single microprocessor. Further, the above-described concepts are not limited to a specific type of positioning device or traffic information data receiver. The navigation system could be integrated in a multimedia system of the vehicle, thereby minimizing hardware outlay. In this case, the processing unit 104, the output device 120, 122, and the input device 132 could be commonly used by several vehicle systems.

The foregoing description of implementations has been presented for purposes of illustration and description. It is not exhaustive and does not limit the claimed inventions to the precise form disclosed. Modifications and variations are possible in light of the above description or may be acquired from practicing the invention. For example, persons skilled in the art will understand and appreciate, that one or more processes, sub-processes, or process steps described in connection with FIGS. 1-4 may be performed by hardware and/or software. Additionally, a navigation system, as described above, may be implemented in software that would be executed within a processor or plurality of processor in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions, i.e., “logic” that may be implemented either in digital form such as digital circuitry or source code or optical circuitry or chemical or biochemical in analog form such as analog circuitry or an analog source such an analog electrical, sound or video signal, and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (hereinafter, “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer, i.e., machine data signals embodied in the carrier wave signal. The computer/machine data signals may include data or software that is transported or interacts with the carrier wave signal. Note also that the implementation may vary between systems. The claims and their equivalents define the scope of the invention.

What is claimed is:

1. A method of operating a navigation system in a vehicle comprising:
receiving traffic information data;
determining a travel route on which the vehicle is moving;
analyzing the traffic information data to detect a relevant event relating to the travel route on which the vehicle moves; and
outputting a navigation information to a vehicle user only if a relevant event is detected.

2. The method of claim 1 further comprising:
if a relevant event is detected, determining an alternative navigation route and including navigation instructions relating to the alternative navigation route that relate to the alternative navigation route.

3. The method of claim 1 where the navigation information output to the vehicle user includes a warning relating to the detected relevant event.

4. The method of claim 1 further comprising entering a dedicated operating mode of the navigation system prior to performing the method.

5. The method of claim 4 where the step of entering the dedicated operating mode is performed in response to activation by the vehicle user.

6. The method of claim 1 comprising:
selecting a predefined travel route to be used as the travel route in the step of analyzing the traffic information data.

7. The method of claim 1 comprising:
obtaining position data of the vehicle by determining the vehicle position relative to a digital map representation;
evaluating the position data to detect if the vehicle is moving on a predefined route; and selecting the predefined route as the travel route to be used in the step of analyzing the traffic information data.

8. The method of claim 6 where the predefined route is a frequently used travel route.

9. The method of claim 6 comprising:
obtaining position data of the vehicle by determining the vehicle position relative to a digital map representation;
evaluating the position data to identify a frequently used travel route; and
storing the identified frequently used travel route as the predefined route.

10. The method of claim 1 comprising:
obtaining position data of the vehicle by determining the vehicle position relative to a digital map representation;
evaluating the position data to determine an expected travel route; and
selecting the expected travel route as the travel route to be used in the step of analyzing the traffic information data.

11. The method of claim 10 where the expected travel route is determined using information on the type of the road on which the vehicle moves.

12. The method of claim 10 where the expected travel route is determined using information on the travel route the vehicle has followed before the time of evaluation.

13. A vehicle navigation system comprising:
a positioning device for determining a vehicle position with respect to a digital map representation and for generating a corresponding position data signal;
a traffic monitoring device for receiving traffic information data and analyzing the traffic information data to detect a relevant event relating to a travel route on which the vehicle moves, where the traffic monitoring device generates a traffic monitoring signal corresponding to the relevant event;
a processing system for generating navigation information on the basis of the position data signal and/or the traffic monitoring data signal;
an output device for outputting the navigation information to a vehicle user;
where the processing system includes a dedicated operating mode in which the navigation information is output to the vehicle user only if a relevant event is detected by the traffic monitoring device.

14. The vehicle navigation system of claim 13 where the output device includes an optical display device and/or a loudspeaker device.

15. The vehicle navigation system of claim 13 comprising:
an input device for activating the dedicated operating mode.

16. The navigation system of claim 13 comprising:
at least one storage device for storing at least one predefined route, where the traffic monitoring device uses the predefined route as the travel route in analyzing the traffic information data.

17. The navigation system of claim 16 where the storage device is configured to store a plurality of predefined routes where the navigation system includes an input device for selecting one of the predefined routes as the travel route to be used by the traffic monitoring device in analyzing the traffic information data.

18. The navigation system of claim 16 where the processing system evaluates position data received from the positioning device and selects the predefined route as the travel route to be used by the traffic monitoring device in analyzing the traffic information data.

19. The navigation system of claim 16 where the processing system evaluates position data received from the positioning device to identify a frequently used travel route and to store the identified frequently used travel route as the predefined route in the storage device.

20. The navigation system of claim 13 where the processing system evaluates position data received from the positioning device to determine an expected travel route and selects the expected travel route as the travel route to be used by the traffic monitoring device in analyzing the traffic information data.

21. A vehicle comprising:
a navigation system; and
a traffic information data receiver for providing a traffic information data signal to the navigation system;
where the navigation system includes:
a positioning device for determining the vehicle position with respect to a digital map representation and for generating a data signal corresponding to the vehicle position;
a traffic monitoring device for receiving traffic information data and analyzing the traffic information data to detect a relevant event relating to a travel route on which the vehicle moves where the traffic monitoring device generates a traffic monitoring signal corresponding to the relevant event;
a processing system for generating navigation information based on the position data signal and/or the traffic monitoring data signal;
an output device for outputting the navigation information to a vehicle user;
where the processing system provides a dedicated operating mode in which the navigation information is output to the vehicle user only if a relevant event is detected by the traffic monitoring device.

22. The vehicle of claim 21 where the traffic information data receiver operates in a vehicle entertainment system.
